(19) United States
(12) Patent Application Publication
(10) Pub. No.: US 2003/0221181 A1
(43) Pub. Date: Nov. 27, 2003

(54) Developing and running selected applications in communications

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/444,995

(22) Filed: May 27, 2003

(30) Foreign Application Priority Data
May 24, 2002 (CA) 2,387,452

(51) Int. Cl. G06F 9/44

(52) U.S. Cl. 717/114

(57) ABSTRACT

At present, there are very few programming languages to develop and run applications in communications, especially in messaging.

The invention includes three new programming languages for this purpose:

QUELAN (question-answer language) to develop and run the quizzes (tests, trivia games)

DIALAN (dialogue language) to develop and run the dialogues

SCELAN (scenario language) procedural programming language with statements _{”}send“ and _{”}receive“ (to send and receive messages)

The program is written and then interpreted or translated. After the program is started, it runs, performing the programming statements. The communication with the user is done by messaging, e.g. via WWW, email or SMS.

### FIELD

The present invention relates to programming languages for developing and running applications in communications.

### BACKGROUND

There are very few programming languages to develop and run applications in communications. Three programming languages and their interpreters are written to solve this situation and to enable the users to develop, very simply, their own communication applications.

### SUMMARY OF THE INVENTION

The invention includes three programming languages for developing and running communication applications.

QUELAN (Question-answer Language)

This is a programming language to develop and run the quizzes (tests, trivia games).

DIALAN (Dialogue Language)

This is a programming language to develop and run the dialogues.

SCELAN (Scenario Language)

This is a programming language with statements “send” and “receive” (to send and receive messages).

### DETAILED DESCRIPTION OF THE INVENTION

Developing and Running Procedure

The user writes the program and saves it to a file. In the case of QUELAN, the user writes questions and answers. In the case of DIALAN, the user writes dialogue in the form of blocks of questions, answers, reactions and further steps. In the case of SCELAN, the user writes a procedural program, in which he/she uses the statements “send” and “receive” to send and receive messages.

The program can be either interpreted (e.g. by Perl interpreter) or translated into other programming languages (C++) or translated into machine code. After the program is saved (translated, compiled), it can run.

The program can be started via WWW pages (by clicking on an icon), via email (by sending email with a keyword and parameters) or via SMS (by sending SMS with a keyword and parameters). For example, the user sends email or an SMS message in the form “GAME XOS FIRST” first, which means, that he/she wants to play the XOS game as the first player.

After the program is started, it performs the initial statements (operations) and then sends a message to the user. For QUELAN, it is the first question of the quiz (test, trivia game). For DIALAN, it is the first question of the first block of the dialogue. For SCELAN, it is the message, contained in the first “send” statement.

After sending the message, the interpreter or running system waits for the reply. A received reply may be assigned to the original sent message, for example, by making a temporary connection, by including some subject information into the sent and received message or by using a reply recognition in communications method.. Thus, the reply is assigned to the sent message, then evaluated and a further procedure taken.

In the case of QUELAN, the reply to the user answers are stored and evaluated (whether good or bad, or scaled). The evaluation can be sent to the user and/or can be added to the quiz (test, trivia game) results. In the case of DIALAN, the keywords of the block are searched in the text of the reply. According to which keywords were found in the reply, the reaction is sent to the user and the next dialogue block to perform is chosen. In the case of SCELAN, the program continues by statements, following the “receive” statement. These statements evaluate somehow the reply, perform defined operations and continue until the next “send” or “receive” statement or until END of program.

QUELAN

Syntax

<program>::=<block>|<program><block>

<block>::=<question><answers and evaluations>

<question>::=<question body><question end>

<question body>::=<text>

<question end>:: ?<answers and evaluations>::=<answers and evaluations variant 1>|<answers and evaluations variant 2>|

<answers and evaluations variant 3>|<answers and evaluations variant 4>|<answers and evaluations variant 5>

<answers and evaluations variant 1>::=<correct answer keywords>

<answers and evaluations variant 2>::=<correct answer keywords><points for correct answer>

<answers and evaluations variant 3>::=<possible answer keywords rows><correct answer letter>

<answers and evaluations variant 4>::=<possible answer keywords rows>

<correct answer letter><points for correct answer>

<answers and evaluations variant 5>::=<possible answer keywords and evaluation row pairs>

<correct answer keywords>::=<correct answer keyword>|

<correct answer keywords>, <correct answer keyword>

<correct answer keyword>::=<name>|<number>|<interval>

<points for correct answer>::=<unsigned integer number>

<possible answer keywords rows>::=<possible answer keywords row>|

<possible answer keywords rows><possible answer keywords row>

<possible answer keywords row>::=<possible answer keywords>

<points for correct answer>::=<unsigned integer number>

<possible answer keywords>::=<possible answer keyword>|

<possible answer keywords>, <possible answer keyword>

<possible answer keyword>::=<name>|<number>|<interval>

<correct answer letter>::=<letter>

<points for possible answer>::=<unsigned integer number>

<possible answer keywords and evaluation row pairs>::=

<possible answer keywords and evaluation row pairs>|

<possible answer keywords and evaluation row pairs><possible answer keywords and evaluation row pair>

<possible answer keywords and evaluation row pair>

<possible answer keywords><points for possible answer>

<name>::=<name begin>|<name body>

<name begin>::=<letter>

<name body>::=<empty>|<letter>|<name body element>|<name body><name body element>

<name body element>::=<letter>|<digit>|<underscore character>|<space>

<text>::=<character>|<text><character>

<number>::=<number sign><number body>

<number sign>::=<empty>|+|−|

<number body>::=<integer part><decimal part>

<integer part>::=<digit>|<integer part><digit>

<decimal part>::=<decimal point><decimal part body>

<decimal point>::=.

<decimal part body>::=<digit |<decimal part body><digit>

<unsigned integer number>::=<integer part>

<interval>::=<lower level>−<upper level>

<lower level>:=<number>

<upper level>:=<number>

<character>::=<letter>|<digit>|<special character>

<letter>::=a|b|c|d|e|f|g|h|i|j|k|l|m|n|o|p|q|r|s|t|u|v|w|x |y|z|A|B|C|D|E|F|G|H|I|J|K|L|M|N|O|P|Q|R|S|T|U|V|W|X|Y|Z

<digit>:=0|1|2|3|4|5|6|7|8|9|

<special character>::=any not letter or digit character (e.g. ‘˜!@#$%\hat{ }&*()−_=+[]\;’,./{}|:<>?space)

<space>::=

Semantics

The program consists of blocks of questions and answers.

The first line of each block is the question.

Question are followed by answering and evaluation lines.

Each answering line consists of possible or correct answer keywords, numbers or intervals.

Possible or correct answer keywords (phrases), numbers and intervals are separated by commas.

When the possible or correct answer is a number, then instead of keyword the possible or correct interval (range) may written in the form “from-to” (e.g. 10-20).

Answering lines may be followed by evaluation lines, containing the item letter (e.g., a, b, c etc.) of the correct answer and/or number of points for each possible or correct answer.

An empty line separates two consecutive question-answer blocks.

There are five variants of the question-answer blocks:

1.

Question

Correct answer keywords

2.

Question

Correct answer keywords

Points for correct answer

3.

Question

Possible answer keywords a

Possible answer keywords b

Possible answer keywords c

. . .

Possible answer keywords n

Correct answer letter a, b, c . . . n

4.

Question

Possible answer keywords a

Possible answer keywords b

Possible answer keywords c

. . .

Possible answer keywords n

Correct answer letter a, b, c . . . n

Points for correct answer

5.

Question

Possible answer keywords a

Points for possible answer a

Possible answer keywords b

Points for possible answer b

Possible answer keywords c Points for possible answer c

. . .

Possible answer keywords n

Points for possible answer n

### EXAMPLE

How many planets has our solar system?

9, nine

Translate the word “nice” into the german language.

schon, schoen, hubsch, huebsch

What is the longest river in the world?

missisipi

Amazon

Nile

c

On which continent is the country Malawi?

Africa

America

Europe

a

3

Which woman do You like most?

Cindy Crawford

Rachel Welch

5

Your wife

6

DIALAN

Syntax

<program>::=<block>|<program><block>

<block>::=<block name><block type><question><answer parts>

<block name>::=<name>

<block type>::=main|subsidiary|end

<question>::=<question body><question end>

<question body>::=<text>

<question end>:: ?

<answer parts>::=<answer parts>|<answer parts><answer part>

<answer part>::=<answer keywords><reaction><next block>

<answer keywords>::=<answer keyword>|<answer keywords>, <answer keyword>|else

<answer keyword>::=<name>|<number>|<interval>

<reaction>::=<text>

<next block>::=<block name>|next|random|end

<name>::=<name begin>|<name body>

<name begin>::=<letter>

<name body>::=<empty>|<letter>|<name body element>|<name body><name body element>

<name body element>::=<letter>|<digit>|<underscore character>|<space>

<text>::=<character>|<text><character>

<number>::=<number sign><number body>

<number sign>::=<empty>|+|−|

<number body>::=<integer part><decimal part>

<integer part>::=<digit>|<integer part><digit>

<decimal part>::=<decimal point><decimal part body>

<decimal point>::=.

<decimal part body>::=<digit|<decimal part body><digit><interval>::=<lower level>−<upper level>

<lower level>:=<number>

<upper level>:=<number>

<character>::=<letter>|<digit>|<special character>

<letter>::=a|b|c|d|e|f|g|h|i|j|k|l|m|n|o|p|q|r|s|t|u|v|w|x |y|z|A|B|C|D|E|F|G|H|I|J|K|L|M|N|O|P|Q|R|S|T|U|V|W|X|Y|Z

<digit>:=0|1|2|3|4|5|6|7|8|9

<special character>::=any not letter or digit character (e.g. ‘˜!@#$%\hat{ }&*()−_=+[]\;’,./{}|:“<>?<space>)

<space>::=

Semantics

The program consists of dialogue blocks.

Each dialogue block consists of 3 rows followed by several trios of rows.

The first row of the block contains the block name.

The second row of the block contains the word “main” for main question, or the word “subsidiary” for question, which is derived from some preceding answer.

The word “end” may be used here to end the dialogue.

The third row of the block contains a question to send from the computer to the conversing person.

A question is followed by trios of rows.

Each of these trios corresponds to one possibility (variant) of the answer, received from the conversing person.

The first row of the trio contains the keywords (phrases), which are expected in the conversing person's answer. These keywords are separated by commas. If one of these keywords occurs in the conversing person's answer, then this trio becomes a valid, computer reaction, written in the second row of the trio, sent to the conversing person. The dialogue continues by the block, the name of which is written in the third row of the trio. Instead of the answer keywords, the word “else” may be written. In this case this trio becomes valid without evaluating the conversing person's answer.

The second row of the trio contains the computer reaction, which is to be sent to the conversing person. It will be sent, when the conversing person's answer contains some keyword, written in the first row of the trio. Instead of the computer reaction, the word “no” may be written here. In this case no computer answer is sent and the dialogue continues directly by the block, which name is written in the third row of the trio.

The third row of the trio contains the name of the block to proceed. This third row may also contain the words: “next”, “random”, “end”. For the word “next”, the block to proceed is the one which follows in the program (file) the present block in the dialogue text. For the name “random”, the block to proceed is chosen by random from the main blocks of the dialogue, which have not performed yet. For the name “end”, the dialogue ends.

Dialogue blocks are separated from each other by empty row.

### EXAMPLE

name

main

Hello, would you please tell me your name?

no

Sorry, since you won't tell me your name then I guess our conversation ends here.

Bye.

end

greeting

main

Hello $answer, How are you today?

good, ok, fine thanks, great, terrific, splendid, superb, groovy

I am glad to hear it!

cat

bad, terrible, rotten, crappy, miserable, depressed, upset

Don't be too down!

weather

other

no next

cat

main

Do you have a cat?

yes, ye, ya, yip

That's nice!

cats name

no

Never mind.

random no next

other

Sorry, do not understand. Please answer following question: NO or YES

cat

cats name

subsidiary

What is the cats' name?

any

So palm this $answer, please.

random no weather

weather

main

What is the weather in your city today?

good, ok, nice, beautiful, , excellent,

Glad to read it!

end dialogue

rainy, sunny, snowing, drizzly, pouring, grey, overcast, bad, cloudy, crazy, storming, blowing,

windy

Hope it will get better.

end dialogue

other

no

end dialogue

end dialogue

end

Sorry, I have no further questions at this time. Bye.

SCELAN

Syntax

<program>::=<program head><program body>

<program head>::=program <program name>

<program name>::=<name>

<program body>::=<block>|<subprogram>|<program body><block>

<block>::=<block begin><block body><block end>

<block begin>begin

<block body><empty>|<statement>|<block body><statement>

<statement>::=<compound statement>|<simple statement>

<compound statement>::=<possible conditional statement>|<block>

<possible conditional statement>::=<empty>|<conditional statement>

<conditional statement>::=<if statement>|<elseif statement>|<else statement>|<while statement>

<if statement>::=if (<relation>)

<elseif statement>::=elseif (<relation>)

<else statement>::=else

<while statement>::=while (<relation>)

<simple statement>::=<conditional statement>|<unconditional statement>

<unconditional statement>::=<unconditional statement body><unconditional statement end>

<unconditional statement body>::=<run statement>|<call statement>|

<assignment statement>|

<receive statement>|<send statement>|<label statement>|<goto statement>|

<quitif statement>|<quitwhile statement>|<return statement>|<stop

statement>|<exit statement>|

<comment statement>

<run statement>::=run <program name>

<call statement>::=call

<assignment statement>

<receive statement>::=receive mymobile <variable name>

<send statement>::=send mymobile <expression>

<label statement>label <name>

<goto statement>::=goto <name>

<quitif statement>::=quitif

<quitwhile statement>::=quitwhile

<return statement>::=return

<stop statement>stop

<exit statement>::=exit

<comment statement>::=comment <comment body>

<comment body>::=any character with the exception of;

<unconditional statement end>

<block end>::=end

<subprogram>::=<subprogram head><subprogram body>

<subprogram head>::=subprogram <subprogram name>

<subprogram name>::=<name>

<subprogram body>::=<empty>|<block>|<subprogram body><block>

<relation>::=<variable name><conditional operator><expression>

<expression>::=<term>|<possible left

bracket><expression><operator><term><possible right bracket>

<term>::=<variable>|<string>|<number>

<variable name>::=$<name>

<name>::=<name begin>|<name body>

<name begin>::=<letter>

<name body>::=<empty>|<letter>|<name body element>|<name body><name body element>

<name body element>::=<letter>|<digit>|<underscore character>

<letter>::=a|b|c|d|e|f|g|h|i|j|k|l|m|n|o|p|q|r|s|t|u|v|w|x |y|z|A|B|C|D|E|F|G|H|I|J|K|L|M|N|O|P|Q|R|S|T|U|V|W|X|Y|Z

<digit>:=0|1|2|3|4|5|6|7|8|9|

<underscore character>::=

<string>::=<string begin><string body>.<string end>

<string begin>::=”

<string body>::=any character with the exception of ”

<string end>::=

<number>::=<number sign><number body>

<number sign>::=<empty>|+|−|

<number body>::=<integer part><decimal part>

<integer part>::=<digit>|<integer part><digit>

<decimal part>::=<decimal point><decimal part body>

<decimal point>::=.

<decimal part body>::=<digit|<decimal part body><digit>

<possible left bracket>::=<empty>|(

<possible right bracket>::=<empty>|)

<operator>::=<conditional operator>|<unconditional operator>

<conditional operator>::=ne|eq|gt|ge|It|le|el|cw|cp

<unconditional operator>::=<concatenation operator>|<arithmetic operator>

<concatenation operator>

<arithmetic operator>::=+|−|*|/|

<empty>::=

Semantics

SCELAN is a simple, structural, procedural language.

The program consists of statements.

Each statement must be written on one row.

The statement must be finished with a semicolon.

There is no semicolon at the end of the following statements: program, subprogram, begin, end, if, elseif, else, while.

The statements program, subprogram, if, elseif, else, while must be followed by a block (begin . . . end).

Conditions following the keywords if, elseif, while must be enclosed in brackets.

Variables names must start with $ and contain letters, digits and underscores.

Texts are written within quotes.

Variables and texts may be joined by space dot space (.).

Spaces are meaningful—syntactical units must be separated by one space.

Program Units

program name—defines name of program (scenario)

subprogram name—defines name of subprogram

if ($variable condition_operator expression)—if valid perform next block

elseif ($variable conditional_operator expression)—if valid perform next block

else—perform next block

while ($variable conditional_operator expression)—if valid repeat cycle

begin—begin of block

end—end of block

run program_name;—run program

call subprogram_name;—call subprogram

$variable=expression;—assign expression to the variable

$variable=eval (expression);—evaluate expression and assign to the variable

$variable=random (from, to);—random number will be generated into the variable

receive mymobile $variable;—receives message into the variable

send mymobile expression;—send message containing the expression

label label_name;—designate place in program, where to jump

goto label_name;—jump to label

quitif;—quit block, which belongs to the actual if statement

quitwhile;—quit block, which belongs to the actual while statement

return;—return from subprogram

stop;—stop present running program

exit;—end of scenario (first program)

comment text;—comment, no program action

Conditional Operators

ne—not equal

eq—equal

gt—greater than

ge—greater or equal

It—less than

le—less

el—equal without respect to capital letters

cw—contains word

cp—contains part

### EXAMPLE

program myvirtualfriend
begin

comment This is example of virtual friend dialogue;
label start_dialogue;
$dialogue_is_about_cat = “no”;
$dialogue_is_about_weather = “no”;
send mymobile “Good morning, how are You today?”;
receive mymobile $answer;
$answer_how_are_you = $answer;
if ($answer eq “good”)
begin

send mymobile “This is good.”;
send mymobile “And what about Your cat?”;
$dialogue_is_about_cat = “yes”;
receive mymobile $answer_cat;

end
elseif ($answer eq “bad”)
begin

send mymobile “Do not cry, it could be worse.”;
call weather;

end
else
begin

send mymobile “Sorry, do not understand. Please send good or bad or END GAME.”;
goto start_dialogue;

end
if ($dialogue_is_about_cat eq “yes”)
begin

send mymobile “My cat is OK.”;

end
elseif ($dialogue_is_about_weather eq “yes”)
begin

send mymobile “Weather is not the best at Vancouver. Cloudy, raining.”;

end
send mymobile “Continue conversation?”;
receive mymobile $answer;
if ($answer cw “yes”)
begin

send mymobile “OK, let continue.”;
goto start_dialogue;

end
else
begin

send mymobile “OK, end of game.”;
exit;

end

end
subprogram weather
begin

send mymobile “What is the weather in Your city today?”;
$dialogue_is_about_weather = “yes”;
receive mymobile $answer_weather;

end

I claim:

1. A system for developing and running communications applications, comprising a programming language selected from the group consisting of
a programming language QUELAN for developing and running quizzes;
a programming language DIALAN for developing and running dialogues; and
a programming language SCELAN with statements for sending and receiving messages.

2. A system according to claim 1, wherein the programming language is QUELAN.

3. A system according to claim 1, wherein the programming language is DIALAN.

4. A system according to claim 1, wherein the programming language is SCELAN.
